(19) United States
(12) Patent Application Publication
(10) Pub. No.: US 2014/0077083 A1
(43) Pub. Date: Mar. 20, 2014

(54) METHOD AND METER FOR DETERMINING GAS QUALITY

(71) Applicants: Michael J. Birnkrant, Rocky Hill, CT (US); Marcin Piech, East Hampton, CT (US); Joseph V. Mantese, Ellington, CT (US)

(72) Inventors: Michael J. Birnkrant, Rocky Hill, CT (US); Marcin Piech, East Hampton, CT (US); Joseph V. Mantese, Ellington, CT (US)

(21) Appl. No.: 13/616,600

(22) Filed: Sep. 14, 2012

(51) Int. Cl. G01J 5/28

(52) U.S. Cl. 250/341.1; 250/343

(57) ABSTRACT

An example method of detecting components of a gas includes detecting substantially all components of a gas using distinct infrared wavelengths within a portion of the infrared spectrum, the portion being less than the entire infrared spectrum.

### BACKGROUND

This disclosure relates generally to determining a quality of a gas.

High-quality gas is typically worth more than low-quality gas. If gas is offered for sale, its price may depend on its quality. Determining the quality of other gases, such as atmospheric gas, indoor air, etc., may be useful for environmental reasons.

Components are the chemically independent constituents of a gas. Natural gas, an example type of gas, is made of several components, some of which are hydrocarbons. The quality of natural gas may be based on the enthalpy of combustion of its individual components.

Methane and the other components of natural gas vary with time in a pipeline and it may be necessary to understand the nature and extent of this variation in composition. Natural gas comprises mainly methane (CH4), with a small proportion of higher hydrocarbons such as ethane (C2H6), propane (C3H8), butane (C4H10) and so on. Inert gases such as nitrogen (N2) and carbon dioxide (CO2) are present at the level of a few percent volume, and various compounds can be present in parts per million (ppm) quantities, including the odorant.

One technique for determining the quality of gas involves separation of individual components of the gas. The separation technique is not suitable for use in some environments, such as when measuring gas within a pipeline. Another technique for determining the quality of gas measures changes in light intensity that has been directed through, and not absorbed by, the gas. The light not absorbed by the gas is spatially dispersed (by wavelength) and forms a light spectrum that is projected onto a detector. The modified light spectrum is compared to the light's actual light spectrum to determine the absorbance spectrum of the fluid. Cross-interference may undesirably distort these measurements making quality analysis difficult.

### SUMMARY

An example method of detecting components of a gas includes detecting substantially all components of a gas using distinct infrared wavelengths within a portion of the infrared spectrum, the portion being less than the entire infrared spectrum.

An example method of detecting components of a gas includes identifying a group of wavelengths associated with components that distort measurements, and then detecting components of the gas utilizing wavelengths that are not in the group of wavelengths.

An example gas component meter includes a filter that is configured to limit detection of a first group of wavelengths associated with components that distort measurements to a detector. A controller is configured to determine a quality of the gas utilizing a second group of wavelengths different than the first group of wavelengths.

### DESCRIPTION OF THE FIGURES

The various features and advantages of the disclosed examples will become apparent to those skilled in the art from the detailed description. The figures that accompany the detailed description can be briefly described as follows:

FIG. 1 shows an example gas component meter.

FIG. 2A shows a plot of transmission percentages from the FIG. 1 meter for some wavelengths in the mid-infrared spectrum.

FIG. 2B shows a plot of transmission percentages from the FIG. 1 meter for other wavelengths in the mid-infrared spectrum.

FIG. 3 shows a plot of transmission percentages from the FIG. 1 meter for wavelengths that are from about eight to eleven microns.

FIG. 4 shows an example method of identifying components utilizing the FIG. 1 meter.

FIG. 5 shows a highly schematic view of how the transmission percentages are used to determine quality.

### DETAILED DESCRIPTION

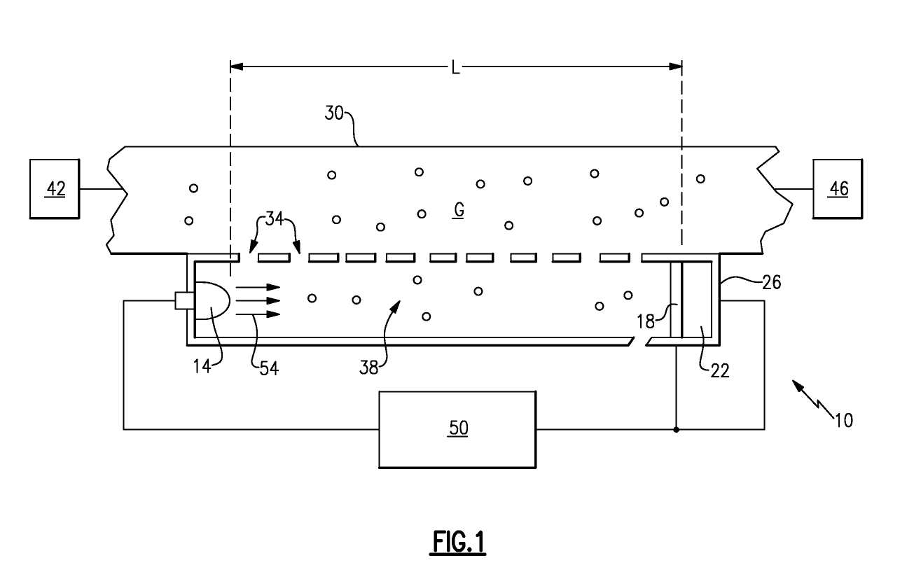

Referring to FIG. 1, an example gas component meter assembly 10 includes an infrared light source 14, a filter 18, and a detector 22 within a housing 26. The housing 26, in this example, is secured to a gas pipeline 30. Apertures 34 within the pipeline 30 and the housing 26 permit gas to communicate between an interior 38 of the housing 26 and the pipeline 30.

Gas G communicates through the pipeline 30 from a supply 42 to a destination 46. The example gas G is natural gas. The supply 42 is a utility company. The destination 46 is a home or business.

The example meter 10 determines the quality of the natural gas within the interior 38 (and thus the composition of gas within the pipeline 30). The composition is used to determine the quality of the natural gas within the interior 38 and the pipeline 30.

In one example, a provider of the supply 42 utilizes the quality information when determining how much to charge the destination for the gas G. The meter 10 is mounted to the pipeline 30 between the supply 42 and the destination 46. In other examples, the meter 10 may be utilized at location of the supply 42, at the location of the destination 46, or at some other location.

The meter 10 includes a controller 50 that is operably linked to the infrared light source 14, the filter 18, and the detector 22. To monitor the components of the natural gas within the interior 38, the controller 50 adjusts the filter 18 to select a group of infrared light waves 54 emitted by 14 within the meter 10. The waves 54 propagate from the infrared light source 14. The waves 54 are mid-infrared spectrum waves ranging, in this example, from three microns to twelve microns. The waves 54 pass through the gas G within the interior 38.

In this example, the filter 18 allows some of the waves 54 to reach the detector 22, and blocks some of the waves 54 from reaching the detector 22. The example filter 18 is a cross-interference/broadband filter device that ensures only waves having lengths from eight to ten microns are detected by the detector 22.

In another example, the infrared light source 14 generates some, rather than all, the waves in the mid-infrared spectrum such as only waves having lengths from eight to ten microns. In such an example, the filter 18 is not used. Another filter, such as a cross-interference filter, may still be used however.

The distance L between the infrared light source 14 and the detector 22 is the optical path length of the waves 54. As the waves 54 move through the gas G toward the detector 22, alkanes in the gas G absorb some of the light. For the wavelengths that pass through the filter 18, the detector 22 detects the light that has not been absorbed by alkanes in the gas G. The controller 50 utilizes this information to determine the percentage of the waves 54 that have been transmitted through the gas G to the detector. The percentages detected by the detector 22 represent the percentages of the waves 54 that have not been absorbed by alkanes in the gas G.

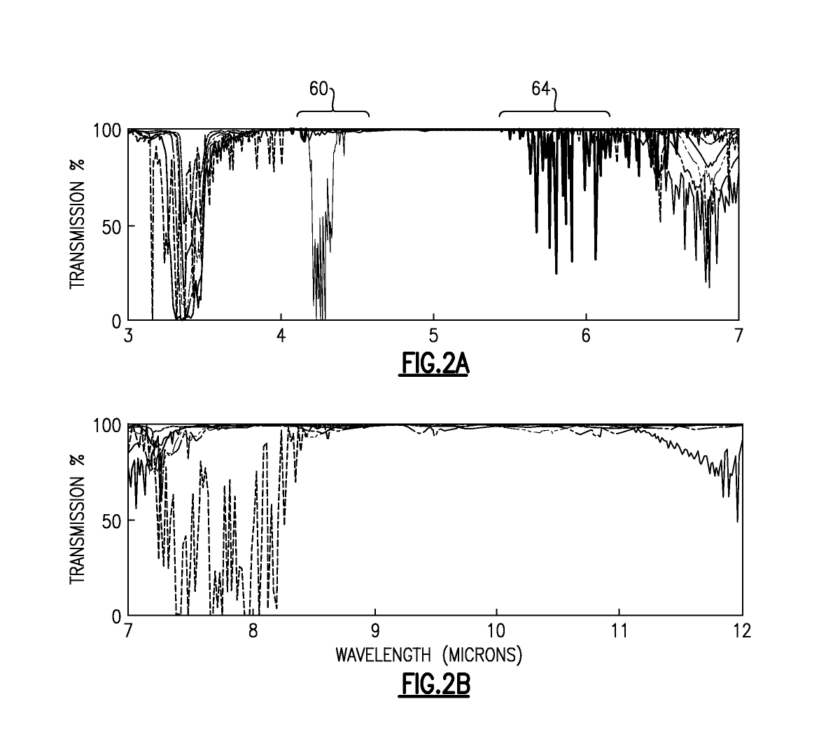

Certain wavelengths are associated with the detection of certain components within the gas. For example, as shown in FIGS. 2A and 2B, an amount of a CO2 component within the gas G may be revealed by the transmission percentages of the wavelengths in area 60. As shown, these wavelengths are slightly greater than four microns. Also, an amount of an H2O component within the gas G is typically measured using wavelengths in area 64 that are near six microns. In prior art systems, transmission percentages were determined for substantially all wavelengths in the mid-infrared spectrum. At least groups of some wavelengths within the mid-infrared spectrum provide transmission percentages that tend to distort measurements of components within the gas G.

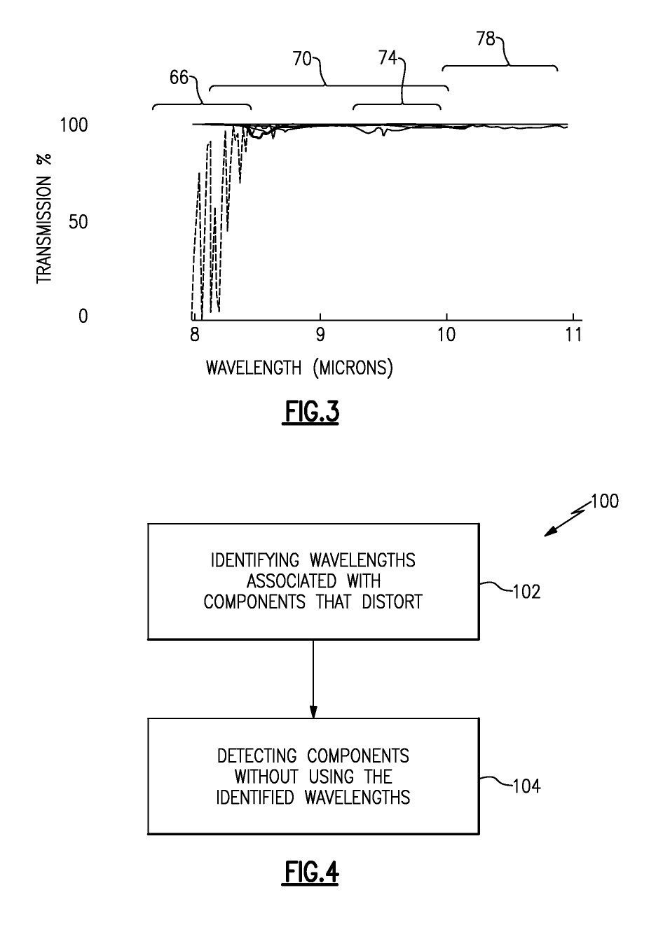

In the example system, wavelengths from eight microns to ten microns are detected by the detector 22. That is, transmission percentages for the gas G are only determined within this range of wavelengths. This example range includes three distinct wavelengths at eight microns, nine microns, and ten microns. The transmission percentages of wavelengths within this range are shown in FIG. 3.

Example components associated with wavelengths in the range of eight to eleven microns include CH4 in area 66, C3H8 in area 74, and C4H10+C5H12+C6H14 in area 78. Multiple alkane species, C2nH2n+2, are associated with wavelengths in area 70. Using the transmission percentages within this range of wavelengths, the example meter 10 is able to detect substantially all the component absorbances within the gas G that are critical to determining quality of the gas G.

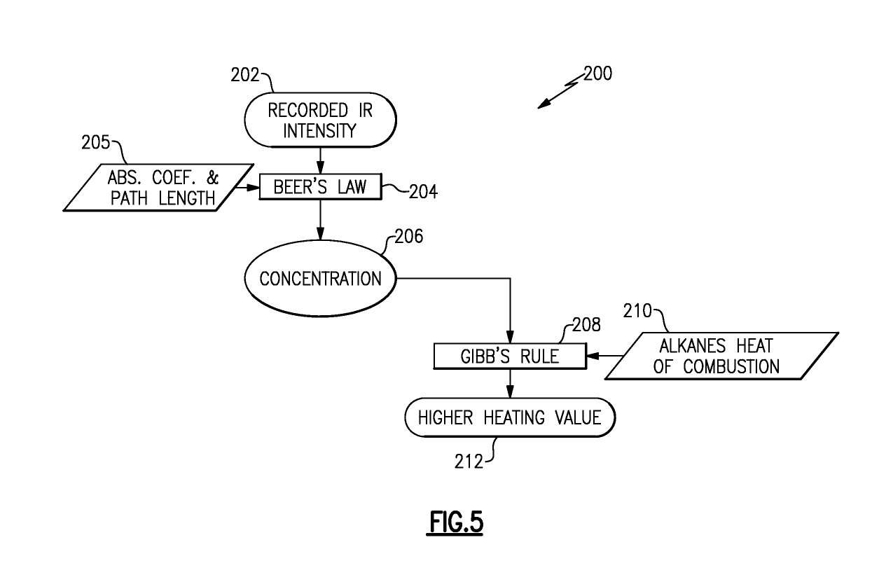

Referring to FIG. 4, an example method 100 of determining components within a gas includes a step 102 of identifying wavelengths associated with components that distort. In this example, those wavelengths would be wavelengths in areas 60 and 64 (FIG. 2A).

The method 100 next, at a step 104, detects components without using the wavelengths identified in the step 102. In an example, the components are detected utilizing wavelengths within the range of eight to ten microns, which does not include the wavelengths in areas 60 and 64.

Referring to FIG. 5, a method 200 utilizes the transmission percentages to determine the quality of natural gas. The method 200 inputs the transmission percentages (or intensities) from a step 202 to a step 204.

The step 204 utilizes Beer's law to determine the concentrations of components using equation 1.

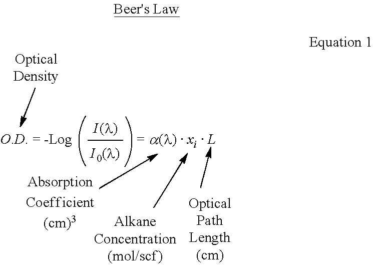

In Equation 1, α is the absorption coefficient of a single component of the natural gas mixture at a given wavelength, x is the alkane concentration, and L is the optical path length of the measurement cell. This information is the input to Equation 1 along with absorption coefficients for specific gas species and optical path length in step 205. These absorption coefficients are calculated from accepted spectral infrared databases.

The output of Beer's law is the concentration of the components at step 206. This information is then used as the input to step 208, the Gibb's rule summarized in Equation 2. In Equation 2, the sum of the heats of combustion for each hydrocarbon component is scaled by the concentration of the particular alkane; x is the alkane concentration, and ΔH_{combustion} is the alkane heat of combustion from step 210. In principle, the simple molar addition of the individual heats of combustion gives rise to the Higher Heating Value, 212. This input in conjunction with a database having the heats of combustion for hydrocarbons, 210, are used to compute the Higher Heating Value, 212.

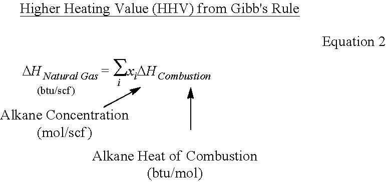

In some examples, the energy flow rate of this mixture of gases is given as:

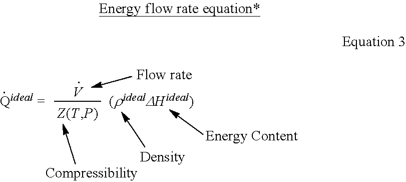

Where Q is the energy flow rate given as a function of: V the volumetric flow rate; Z the compressibility factor; ρ the density and ΔH the heat of combustion, energy content or higher heating value. The energy content of natural gas is an intensive thermodynamic property. A volume of natural gas has N+1 degrees of freedom, where N is the number of constituents that make up the gas mixture. In order to calculate, the exact energy content value, N+1 measurements would need to be taken. In a typical natural gas sample this would mean greater than nine independent measurements. This measurement of nine or more wavelengths corresponds to monitoring the composition of natural gas components from methane (CH3) to octane (C8H18) or higher.

Specifically, the system of linear equations corresponding to the components of the gas need to be solved. The algorithmic development for calculating the High Heating Value of a multispecies natural gas mixture is as follows. The absorption of infrared light at a particular wavelength for a natural gas mixture can be explained using Beer's law. The expansion of Beer's law at a given wavelength to take into account multiple gas species is given below as Equation 4.

O.D._{λ1}=αₐ₁xₐL+α_{b1}x_{b}L+α_{c1}x_{c}L+. . . +αⱼ₁xⱼL Equation 4

Notice that from the expansion of Beer's law that the absorption of infrared light at a particular wavelength is the summation of absorption from individual components.

The expansion of Beer's law at a different given wavelength to take into account multiple gas species is given below as Equation 5.

O.D._{λ2}=αₐ₂xₐL+α_{b2}x_{b}L+α_{c2}x_{c}L+. . . +αⱼ₂xⱼL Equation 5

Both these equations are linear. The optical density and absorption coefficients are unique and different for each wavelength and gas mixture. However, the concentration of the gas species remains constant in each equation. Thus, a system of linear equations can be compiled to convert absorption to concentration. The system of linear equations can be converted to matrix form as shown below:

$$[ \begin{matrix}O \cdot {D}_{\cdot {λ}_{1}} \\ ⋮ \\ O \cdot {D}_{\cdot {λ}_{x}}\end{matrix} ] = [ \begin{matrix}{α}_{a 1} {L}_{1} & … & {α}_{j 1} {L}_{1} \\ ⋮ & ⋱ & ⋮ \\ {α}_{ax} {L}_{x} & … & {α}_{jx} {L}_{x}\end{matrix} ] [ \begin{matrix}{x}_{a} \\ ⋮ \\ {x}_{j}\end{matrix} ]$$

A simpler representation of the matrix is:

O̅.̅D̅.̅= α̅L̅x̅)

In order to solve for concentration, x, two methods are available. If the matrix is square than the solution to the equation above is dependent on inverting the operator:

x̅= O̅.̅D̅.̅( α̅L̅⁻¹)

The solution above exists for a well defined system. In practice, a system of equations is either over or under determined. In this case an approximation of the solution needs to be made to fit the observed data. This method is normally referred to as the least squares method and is shown below (The superscript T refers to the transpose of the matrix α̅L̅):

x̅=( α̅L̅^{T} α̅L̅)⁻¹ α̅L̅^{T} O̅.̅D̅.̅

Approaches in the past have relied on determining regions of the infrared spectra that could be speciated. In other words, concentrations of all species within a natural gas were determined individually. Only then was the higher heating value calculated. By contrast, methods disclosed here remove this limitation. Specifically, this method is applicable to convoluted spectral ranges. Convolution is due to multiple alkane absorption coefficients at a particular wavelength contributing to the overall absorption coefficient at a particular wavelength. In this region or with an apparatus that measures a convoluted spectrum, speciation is difficult. However, gas quality still can be determined. This is accomplished by taking the dot product and minimizing the Euclidean Normal, ∥ α̅L̅x̅− O̅.̅D̅.̅∥ instead of determining gas species. The higher heating value for the mixture is then the dot product between x̅, and the heats of combustions of hydrocarbon components.

The higher heating value for natural gas mixture can be determined to an arbitrary accuracy by calculating the Euclidean Normal.

The use of the method described above and minimizing the Euclidean Normal to calculate natural gas quality are features of the disclosed examples. These features were used when evaluating a set of wavelengths in the range of eight to eleven microns.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A method of detecting components of a gas, comprising:
detecting substantially all components of a gas using distinct infrared wavelengths within a portion of the infrared spectrum, the portion being less than the entire infrared spectrum.

2. The method of claim 1, wherein the distinct infrared wavelengths are 8 microns, 9 microns, and 10 microns.

3. The method of claim 1, wherein the gas is natural gas.

4. The method of claim 1, including calculating a quality of the gas using information from the detecting.

5. The method of claim 1, wherein the detecting comprises determining a transmission percentage.

6. The method of claim 1, including converting absorption of the plurality of distinct infrared wavelengths to a concentration of species within the gas using a system of linear equations, and using a least squares method to approximate a solution to the system of equations.

7. The method of claim 6, calculating the Euclidean Normal to determine a higher heating value of the gas.

8. The method of claim 1, wherein the portion of the infrared spectrum is convoluted.

9. A method of detecting components within a gas, comprising:
identifying a group of wavelengths associated with components that distort measurements; and
detecting components of the gas utilizing wavelengths that are not in the group of wavelengths.

10. The method of claim 9, wherein CO₂ and H₂O are components that distort measurements.

11. The method of claim 9, wherein the measurements comprise quality measurements of the gas.

12. The method of claim 9, wherein the gas is natural gas.

13. The method of claim 9, wherein the detecting comprises determining a transmission percentage.

14. The method of claim 9, wherein the detecting comprises utilizing wavelengths that are from 8 microns to 11 microns in length.

15. The method of claim 9, wherein the group of wavelengths are less then 8 microns.

16. The method of claim 9, wherein the group of wavelengths are greater than 11 microns.

17. A gas component meter, comprising:
a filter configured to limit movement of a first group of wavelengths that are associated with components that distort measurements to a detector; and
a controller configured to determine a quality of the gas utilizing a second group of wavelengths different than the first group of wavelengths.

18. The gas component meter of claim 17, wherein the gas is a natural gas.

19. The gas component meter of claim 17, wherein the first group of wavelengths and the second group of wavelengths part infrared comprise infrared waves from an infrared light source.

20. The gas component meter of claim 17, wherein the first group of wavelengths is associated with H₂O, CO₂, or both.
